(19) United States
(12) Patent Application Publication
(10) Pub. No.: US 2024/0162027 A1
(43) Pub. Date: May 16, 2024

(54) System and Method for Variable FFT Analysis Windows in Mass Spectrometry

(71) Applicant: DH Technologies Development Pte. Ltd., Singapore (SG)

(72) Inventor: James HAGER, Concord (CA)

(21) Appl. No.: 18/281,722

(22) PCT Filed: Mar. 17, 2022
(86) PCT No.: PCT/IB2022/052446

§ 371 Date: Sep. 12, 2023

Related U.S. Application Data
(60) Provisional application No. 63/162,895, filed on Mar. 18, 2021.

(51) Int. Cl. H01J 49/42; H01J 49/06

(52) U.S. Cl. CPC H01J 49/42; H01J 49/063

(57) ABSTRACT

In one aspect, a mass spectrometer is disclosed, which comprises an ion source for receiving a sample and ionizing at least a portion of the sample to generate a plurality of ions, and a Fourier Transform (FT) mass analyzer that is configured to receive at least a portion of said plurality of ions at an inlet thereof. The ions exiting the FT are detected by an ion detector, which generates a transient oscillating ion detection signal. The analyzer processes the ion detection signal via application of an FT thereto, where the FT window width is selected to optimize a mass signal associated with at least one target ion of interest.

### RELATED APPLICATIONS

This application claims priority to U.S. Provisional Application No. 63/162,895 filed on Mar. 18, 2021, the contents of which are incorporated herein in their entirety.

### BACKGROUND

The present teachings are generally directed to methods and systems for performing Fourier Transform (FT) mass spectrometry, and particularly to such methods and systems that allow optimizing mass signals associated with one or more target ions of interest.

Mass spectrometry (MS) is an analytical technique for determining the elemental compositions of test substances with both quantitative and qualitative applications. For example, MS can be used to identify unknown compounds, to determine the isotopic composition of elements in a molecule, and to determine the structure of a particular compound by observing its fragmentation, as well as to quantify the amount of a particular compound in the sample.

Fourier Transform (FT) mass spectrometry is one method of performing mass spectrometry in which ions generated via ionization of a sample can be excited at their secular frequencies and the excited ions can be detected by an ion detector, which generates a temporally transient oscillating ion detection signal. The transient oscillating ion detection signal can be converted from the time domain to frequency domain so as to obtain signals associated with the secular frequencies of the detected ions. These secular frequencies can then be employed to derive m/z ratios of the ions.

In many cases, the ionization of a sample can result in the generation of a plurality of ions having different m/z ratios, which can lead to loss of intensity fidelity in the resulting mass spectra obtained via FT of a transient oscillating ion detection signal generated via a superposition of contributions from the ions with different m/z ratios.

Accordingly, there is a need for improved methods and systems for performing FT mass spectrometry.

### SUMMARY

In one aspect, a mass spectrometer is disclosed, which comprises an ion source for receiving a sample and ionizing at least a portion of the sample to generate a plurality of ions, and a Fourier Transform (FT) mass analyzer that is configured to receive at least a portion of said plurality of ions at an inlet thereof. In some embodiments, the FT mass analyzer can include a plurality of rods arranged in a multipole configuration so as to provide a passageway for transmission of ions from the inlet to an outlet through which ions can exit the FT mass analyzer. An RF voltage source can apply RF voltage(s) to the rods of the FT mass analyzer so as to generate an electromagnetic field within the ion passageway for radially confining the ions as they pass through the passageway. The mass spectrometer can further include a voltage source for applying a voltage pulse to at least one of said rods (e.g., across two opposed rods) for radially exciting at least a portion of the ions at secular frequencies thereof such that an interaction of the radially excited ions with fringing fields in proximity of the outlet of the mass analyzer can convert the radial oscillations of the ions into axial oscillations as the ions exit the FT mass analyzer.

An ion detector positioned downstream of the FT mass analyzer can detect at least a portion of the ions exiting the FT mass analyzer and generate a transient oscillating ion detection signal. An analyzer in communication with the ion detector can receive the transient oscillating ion detection signal and can apply an FT to the ion detection signal to convert the time-domain ion detection signal to the frequency domain, thereby generating secular frequencies of the ions. Further, the analyzer is configured to apply the FT to the transient oscillating ion signal with an FT window width that is selected to optimize a signal associated with a secular frequency of at least one target ion, when the target ion is present in the sample. By way of example, the optimization of the secular frequency signal can include, for example, the maximization of the signal intensity and/or the width of the signal.

In some embodiments, the multipole configuration of the rods can be a quadrupole configuration.

In some embodiments, the analyzer can be configured to determine the FT window width based on an m/z ratio associated with the target ion.

In some embodiments, the analyzer is configured to determine the FT window width by initially applying an FT with a wide window width (e.g., a window width greater than about 1 millisecond) to the transient oscillating ion detection signal to obtain information regarding secular frequencies of said plurality of ions. The analyzer can then identify a secular frequency associated with a target ion of interest from among the secular frequencies derived based on the FT analysis of the transient oscillating ion detection signal. The analyzer can then determine an m/z ratio of the target ion based on the identified secular frequency.

Once the m/z ratio of the target ion is determined, the analyzer can calculate the FT window width based on the m/z ratio of the target ion. For example, the FT window width can be proportional to the square root of the m/z ratio, where the proportionality constant can be determined, for example, based on a previously-determined optimal FT window width for a calibrant ion. Such a calibration ion can be, for example, an ion that is inherently present in a sample, or alternatively, such a calibration ion may be added to a sample under investigation. In some embodiments, an optimal FT window width can be determined theoretically, e.g., based on the known ion energies (which can be used to obtain ion velocities), and the length of the FT mass analyzer, which can in turn allow the calculation of the ion transient time through the FT mass analyzer.

In a related aspect, a method of performing mass spectrometry is disclosed, which includes ionizing a sample to generate a plurality of ions, introducing at least a portion of the ions into a Fourier Transform (FT) mass analyzer via an inlet thereof, and radially exciting at least a portion of the ions within the FT mass analyzer such that interaction of at least a portion of the radially excited ions with fringing fields in proximity of an outlet of said FT mass analyzer will convert radial oscillations of the excited ions into axial oscillations as the ions exit the FT mass analyzer.

At least a portion of the ions exiting the FT mass analyzer is detected so as to generate a transient oscillating ion detection signal, and an FT of the ion detection signal is obtained so as to generate frequency domain signals indicative of one or more secular frequencies of one or more of the ions, where an FT window width associated with said ion detection signal is selected so as to optimize a secular frequency signal corresponding to at least one target ion, when said target ion is present in said plurality of ions.

In some embodiments, the method can further include radially confining the ions within the FT mass analyzer prior to their radial excitation. By way of example, when the FT mass analyzer is implemented using a quadrupole arrangement of a plurality of rods, RF voltages can be applied to the rods in a manner known in the art to provide an RF radial confinement field.

In some embodiments of the above method, the FT window width can be determined based on the m/z ratio of the target ion. Alternatively, or in addition, the FT window width can be determined by processing the transient oscillating ion detection signal by multiple test FT window widths and choosing an FT window width (herein also referred to as an optimal FT window width) from among those test FT window widths that optimizes the signal associated with the secular frequency of the target ion. The transient oscillating ion detection signal can then be processed by employing the optimal FT window width. In some embodiments, the optimization of the signal associated with the secular frequency of the target ion can include maximizing the intensity of the peak corresponding to the secular frequency of the target ion and/or minimizing the peak's width (e.g., the full width at half maximum).

In some embodiments, the FT window width can be, for example, in a range of about 1 millisecond to about 3 milliseconds, though other FT window widths can also be employed based on particular applications and/or sample compositions.

As noted above, in some embodiments, the FT mass analyzer includes a plurality of rods arranged in a multipole configuration providing a passageway for transit of the ions through FT mass analyzer.

In some embodiments, one or more RF voltages can be applied to the rods to provide an RF field for the radial confinement of the ions. In some such embodiments, the RF voltages can have a frequency in a range of about 0.8 MHz to about 3 MHz and an amplitude, e.g., a zero-to-peak amplitude, in a range of about 100 volts to about 1500 volts.

In some embodiments, the radial excitation of the ions can be achieved via application of a DC voltage pulse across two opposed rods of the FT mass analyzer. In some such embodiments, the DC voltage pulse can have an amplitude in a range of about 20 to about 100 volts.

Further understanding of various aspects of the present teachings can be obtained by reference to the following detailed description in conjunction with the associated drawings, which are described briefly below.

### BRIEF DESCRIPTION OF THE DRAWINGS

FIG. 1 is a flow chart depicting various steps in a method according to an embodiment of the present teachings for performing FT mass spectrometry,

FIG. 2A schematically depicts a quadrupole mass analyzer according to an embodiment of the present teachings,

FIG. 2B is a schematic end view of the quadrupole rods of the mass analyzer depicted in FIG. 2A,

FIG. 2C schematically depicts a square voltage pulse suitable for use in some embodiments of a mass analyzer according to the present teachings,

FIG. 3 schematically depicts one exemplary implementation of an analysis module suitable for use in a mass analyzer according to the present teachings,

FIG. 4 is a schematic view of a mass spectrometer in which a mass analyzer according to the present teachings is incorporated,

FIG. 5A shows a transient oscillating ion detection signal for protonated reserpine ion at m/z 609 obtained via a FT mass spectrometer,

FIG. 5B shows an FT of the ion detection signal depicted in FIG. 5A,

FIG. 5C shows a mass spectrum of the protonated reserpine ion obtained by employing the FT of the ion detection signal (which is shown in FIG. 5B),

FIG. 6 provides a comparison between the transient oscillating ion detection signals obtained for singly charged reserpine and cesium ions using the same FT mass spectrometer, and

FIG. 7 shows multiple Fourier Transforms of a transient ion detection signal for singly charged cesium ion, obtained with varying the FT window width employed to process the ion detection signal.

### DETAILED DESCRIPTION

The present teachings are generally directed to methods and systems for performing Fourier Transform (FT) mass spectrometry. More specifically, the present teachings are generally directed to methods and systems for performing FT mass spectrometry using an FT window (herein also referred to as FT window width, FT apodization window, etc.) that is selected so as to enhance, and preferably optimize, a signal intensity of at least one mass peak associated with at least one target ion of interest, when present in a sample under investigation via FT mass spectrometry.

In many embodiments, the methods and systems disclosed herein can be employed to achieve an accurate set of mass peak intensities for a plurality of ions having different masses while minimizing, and preferably preventing, the loss of intensity for ions exhibiting faster decaying transient oscillating ion detection signals, e.g., ions having low m/z ratios (e.g., m/z ratios less than about 200).

It has been discovered that the use of a uniform FT window width for the FT analysis of a transient oscillating ion detection signal generated by a plurality of ions having different m/z ratios can lead to loss of intensity fidelity in the signal amplitudes in resulting mass spectra. In particular, in instruments in which the ions with different m/z ratios enter an FT mass analyzer with a substantially similar energy, the mass differences between the ions can lead to mass dependence of the duration of the transient oscillating ion detection signal.

In some embodiments discussed below, the degradation of the mass signal intensity associated with a target ion due to such mass dependence of the duration of the ion detection signal can be minimized, and preferably eliminated, by selecting an FT window width for the FT analysis of the transient oscillating ion detection signal that will optimize the signal associated with the secular frequency of the target ion, when the target ion is present in a sample under investigation.

More specifically, as discussed in more detail below, in some embodiments, a method of performing FT mass spectrometry in accordance with the present teachings can include using an FT mass analyzer to acquire a transient oscillating ion detection signal for a plurality of ions generated via ionization of a sample under investigation. An FT of the transient oscillating ion detection signal is obtained with an FT window width that is sufficiently large to ensure that the secular frequencies of all ions of interest (and hence the mass spectrum thereof), when present in the sample, can be identified in the frequency domain signal generated by the FT of the ion detection signal. Following the identification of a peak of interest, the FT of the transient ion detection signal can be performed with different FT window widths to maximize the intensity and/or peak associated with an ion of interest.

In some cases, the ion energy and/or the window associated with the acquisition of the oscillating ion detection signal can be adjusted to optimize the FT signal(s) associated with one or more target ions. In some cases, the acquisition and analysis of mass data according to the present teachings may lead to the conclusion that the use of one or more different mass spectrometer parameters, such as an RF radial confinement voltage, a DC excitation voltage, and/or collision gas, may be needed.

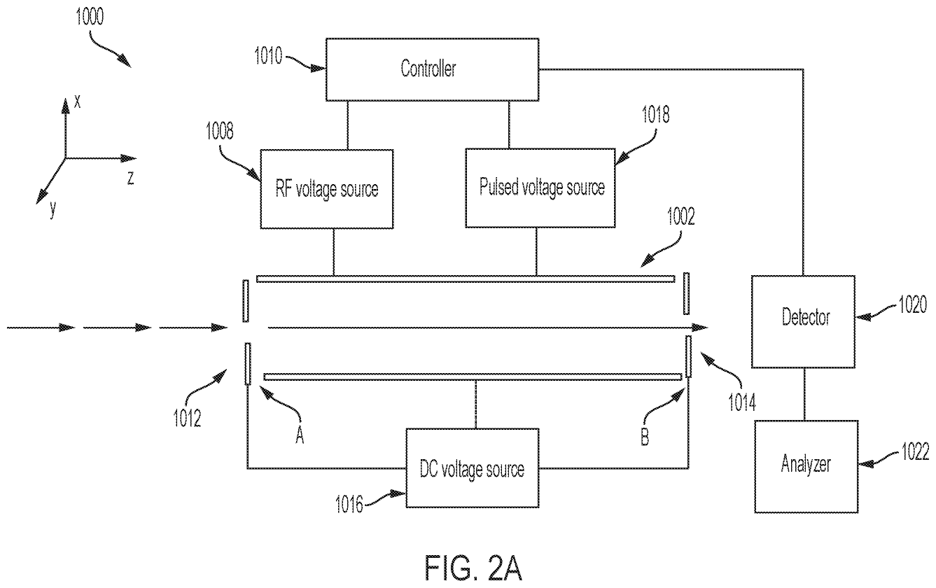

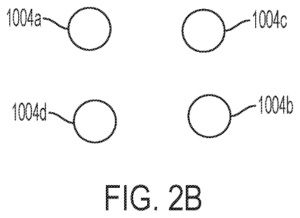

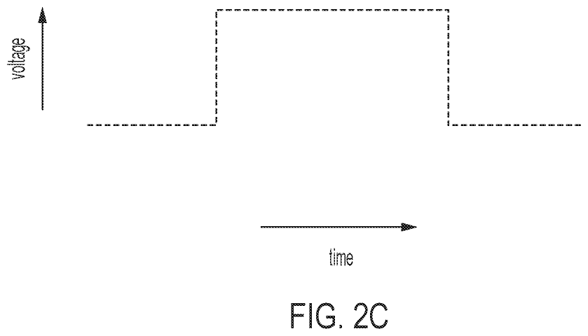

Various terms are used herein consistent with their common meanings in the art. The term “radial” is used herein to refer to a direction within a plane perpendicular to the axial dimension of the quadrupole rods set (e.g., along z-direction in FIG. 2A). The terms “radial excitation” and “radial oscillations” refer, respectively, to excitation and oscillations in a radial direction. e.g., in a direction perpendicular to z-direction in FIG. 2A.

The term “about” as used herein to modify a numerical value is intended to denote a variation of at most 5 percent about the numerical value. The terms “Fourier Transform (FT) window width,” or “FT measurement window,” or “measurement time window,” or “FT apodization window” are used herein interchangeably to refer to a temporal portion of a transient oscillating ion detection signal that will be subjected to a Fourier Transform operation (e.g., a Fast Fourier Transform (FFT)) to convert the time-domain ion detection signal to a frequency-domain signal indicative of secular frequencies of one or more ions present in a sample under investigation. Various shapes for the FT apodization window can be used. Some examples of such apodization windows include, without limitation, a Gaussian window, a square box window, among others.

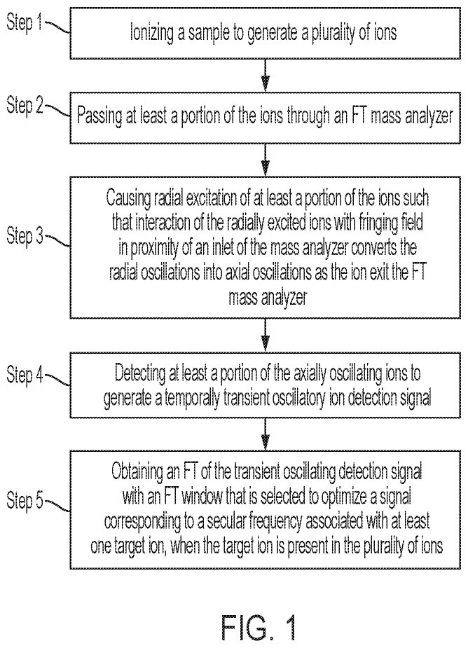

With reference to the flow chart of FIG. 1, a method according to an embodiment of the present teachings for performing Fourier Transform (FT) mass spectrometry includes ionizing a sample to generate a plurality of ions (step 1), and introducing at least a portion of the plurality of ions into an FT mass analyzer, which can include, in some embodiments, a plurality of rods that are arranged in a multipole configuration extending from an input port (herein also referred to as an inlet) for receiving ions to an output port (herein also referred to as an outlet) through which ions exit the mass analyzer (step 2).

At least one RF voltage can be applied to at least one of the rods of the FT mass analyzer, e.g., RF voltages with similar amplitudes but opposite phases can be applied to two pairs of the rods, so as to generate an RF electromagnetic field for providing radial confinement of the ions as they pass through the multipole rod set.

With continued reference to the flow chart of FIG. 1, the method can further include exciting radial oscillations of one or more of the ions at secular frequencies thereof such that fringing fields in proximity of the outlet of the FT mass analyzer would convert the radial oscillations of the excited ions into axial oscillations as the excited ions exit the multipole rod set (step 3). The axially oscillating ions are detected by a downstream ion detector, which generates a transient oscillating ion detection signal (step 4). An FT of the transient oscillating ion detection signal can be obtained using an FT window width that is selected to optimize a signal corresponding to a secular frequency associated with at least one target ion, when that target ion is present in the plurality of ions (step 5).

In some embodiments, the selection of an optimal FT window width for the detection of a target ion of interest can be achieved by initially obtaining an FT of the oscillating ion detection signal with an FT window width that is sufficiently wide so as to ensure that signals associated with the secular frequencies of all (or substantially all) ions suspected of being present in the sample will appear in the FT spectrum. The secular frequency of the target ion of interest can then be used to determine an m/z ratio of the target ion in a manner known in the art, and discussed briefly below.

By way of example, in some embodiments, the multipole ion guide can be in the form of a quadrupole ion guide, where an excitation pulse is applied between two rod electrodes of the quadrupole ion guide to induce radial motion. Excited ions oscillate in the fixed RF field at their secular frequencies, which are given by the m/z of the ion and properties of the confinement field, as is shown below.

By way of example, in some embodiments, the optimal FT window width for performing an FT of the oscillating ion detection signal can then be determined based on the m/z ratio of the target ion of interest. For example, in some such embodiments, the optimal FT window width can be proportional to the square root of the m/z ratio of the target ion relative to an m/z ratio of another ion present in the sample (e.g., an ion present in the sample that can be used as a calibrant ion).

In some embodiments in which the multipole rod set has a quadrupole configuration, an excitation pulse can be applied across two opposed rod electrodes to induce radial excitation (oscillation) of the ions. In some embodiments, the excitation pulse can be configured to cause radial excitation of substantially all ions within the FT mass analyzer at their secular frequencies. The secular frequency, ω, of an ion is given in terms of its m/z ratio and the properties of the radial confinement field (e.g., the amplitude and frequency of the applied RF voltage) in accordance with the following relations:

$$ω = \frac{βΩ}{2} \qquad Eq . ( 1 )$$

$${q}_{x} = - {q}_{y} = \frac{4 zV}{{Ω}^{2} {r}_{0}^{2} m} \qquad Eq . ( 2 )$$

$${β}^{2} = a + \frac{{q}^{2}}{{( β + 2 )}^{2} - a - \frac{{q}^{2}}{{( β + 4 )}^{2} - a - \frac{{q}^{2}}{{( β + 6 )}^{2} - a - …}}} + \frac{{q}^{2}}{{( β - 2 )}^{2} - a - \frac{{q}^{2}}{{( β - 4 )}^{2} - a - \frac{{q}^{2}}{{( β - 6 )}^{2} - a - …}}} \qquad Eq . ( 3 )$$

where z is the charge on the ion, U is the DC voltage on the rods, V is the RF voltage amplitude, Ω is the angular frequency of the RF, and r₀ is the characteristic dimension of the quadrupole. The radial coordinate r is given by the following:

r²=x²+y² Eq.(4)

In addition, when q<˜0.4 the parameter β is given by the following relation:

$${β}^{2} = a + \frac{{q}^{2}}{2} \qquad Eq . ( 5 )$$

These radial secular oscillations are converted into oscillations in the ion current at the detector after passing through an appropriate exit fringing field in proximity of the outlet of the ion guide.

By way of illustration and without being limited to any particular theory, the application of the RF voltage(s) to the quadrupole rods can result in the generation of a two-dimensional quadrupole potential as defined in the following relation:

$${φ}_{2 D} = {φ}_{0} \frac{{x}^{2} - {y}^{2}}{{r}_{0}^{2}} \qquad Eq . ( 6 )$$

where, φ₀ represents the electric potential measured with respect to the ground, and x and y represent the Cartesian coordinates defining a plane perpendicular to the direction of the propagation of the ions (i.e., perpendicular to the z-direction). The electromagnetic field generated by the above potential can be calculated by obtaining a spatial gradient of the potential.

Again without being limited to any particular theory, to a first approximation, the potential associated with the fringing fields in the vicinity of the inlet and the outlet of the quadrupole may be characterized by the diminution of the two-dimensional quadrupole potential in the vicinity of the inlet and the outlet of the quadrupole by a function ƒ(z) as indicated below:

φ_{FF}=φ_{2D}ƒ(z) Eq.(7)

where, φ_{FF} denotes the potential associated with the fringing fields and φ_{2D} represents the two-dimensional quadrupole potential discussed above. The axial component of the fringing electric field (E_{Z,quad}) due to the diminution of the two-dimensional quadrupole field can be described as follow:

$${E}_{z , quad} = - {φ}_{2 D} \frac{\partial f ( z )}{\partial z} \qquad Eq . ( 8 )$$

Such a fringing field allows the conversion of the radial oscillations of ions excited via application of a voltage pulse to one or more of the quadrupole rods (and/or one or more auxiliary electrodes) to axial oscillations, where the axially oscillating ions are detected by a detector.

In some other embodiments, the selection of an optimal FT window width for use in obtaining an FT of the oscillating ion detection signal can be achieved by acquiring multiple Fourier Transforms of the oscillating ion detection signal with different FT window widths and choosing an FT window width from among those FT window widths that optimizes (e.g., maximizes the intensity) of the signal associated with the secular frequency of the target ion in the FT spectrum.

By way of example, and without any limitation, in some embodiments, an optimal FT window width for the detection of ions with m/z ratios in a range of about 100 to about 2000 amu can be in the range of about 0.4 millisecond to about 2 milliseconds, though other FT window widths can also be utilized.

By way of further illustration, in some embodiments, the FT of an oscillating ion detection ion signal can be represented by the following relation:

F(ω)=ΣAω₁+Bω₂+Cω₃+ . . . +Nω_{N} Eq. (9)

where,
ω₁, ω₂, ω₃, . . . , ω_{N} represent secular frequencies of a plurality of ions having different m/z ratios, and
A, B, C, . . . , N represent intensities of secular frequencies of said ions.

In some such embodiments, the FT window width for obtaining an FT of the oscillating ion detection signal can be selected so as to optimize at least one of the parameters A, B, C, . . . , N, indicative of the intensities of the secular frequencies of the plurality of ions.

The present teachings for performing FT mass spectrometry can be implemented in a variety of different types of mass spectrometers in which FT mass analyzers are employed.

With reference to FIGS. 2A, 2B, and 2C, a mass analyzer 1000 that can be used in the practice of the present teachings includes a quadrupole rod set 1002 that extends from an inlet (A) configured for receiving ions to an outlet (B) through which ions can exit the quadrupole rod set. In this embodiment, the quadrupole rod set includes four rods 1004a, 1004b, 1004c, and 1004d (herein collectively referred to as quadrupole rods 1004), which are arranged relative to one another to provide a passageway therebetween through which ions received by the quadrupole rod set can propagate from the inlet (A) to the outlet (B).

In this embodiment, the quadrupole rods 1004 have a circular cross-section while in other embodiments they can have a different cross-sectional shape, such as hyperbolic.

The mass analyzer 1000 can receive ions, e.g., a continuous stream of ions, generated by an ion source (not shown in this figure). A variety of different types of ion sources can be employed. Some suitable examples include, without limitation, an electrospray ionization device, a nebulizer assisted electrospray device, a chemical ionization device, a nebulizer assisted atomization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, DESI, among others.

The application of radiofrequency (RF) voltages to the quadrupole rods 1004 can provide a quadrupolar field for radial confinement of the ions as they pass through the quadrupole. The RF voltages can be applied to the rods with or without a selectable amount of a resolving DC voltage applied concurrently to one or more of the quadrupole rods.

In some embodiments, the RF voltages applied to the quadrupole rods 1004 can have a frequency in a range of about 0.8 MHz to about 3 MHz and an amplitude (e.g., a zero-to-peak amplitude) in a range of about 100 volts to about 1500 volts, though other frequencies and amplitudes can also be employed. In this embodiment, an RF voltage source 1008 operating under the control of a controller 1010 provides the required RF voltages to the quadrupole rods 1004.

In some embodiments, the pressure within the quadrupole rod set can be maintained in a range of about 1×10⁻⁶ Torr to about 1.5×10⁻³ Torr, e.g., in a range of about 8×10⁻⁶ Torr to about 5×10⁻⁴ Torr.

The application of the RF voltage(s) can result in the generation of a quadrupolar field within the quadrupole characterized by fringing fields in the vicinity of the inlet (entrance) and the outlet (exit) of the quadrupole rod set. As discussed in more detail below such fringing fields can couple the radial and axial motions of the ions. By way of example, the diminution of the quadrupole potential in the regions in the proximity of the outlet (B) of the quadrupole rod set can result in the generation of fringing fields, which can exhibit a component along the longitudinal direction of the quadrupole (along the z-direction). In some embodiments, the amplitude of this electric field can increase as a function of increasing radial distance from the center of the quadrupole rod set.

In this embodiment, the mass analyzer 1000 further includes an input lens 1012 disposed in proximity of the inlet of the quadrupole rod set and an output lens 1014 disposed in proximity of the outlet of the quadrupole rod set. A DC voltage source 1016, operating under the control of the controller 1010, can apply two DC voltages, e.g., in a range of about 1 to 50 V attractive relative to the DC offset of the quadrupole, to the input lens 1012 and the output lens 1014.

In some embodiments, the DC voltage applied to the input lens 1012 causes the generation of an electric field that facilitates the entry of the ions into the mass analyzer. Further, the application of a DC voltage to the output lens 1014 can facilitate the exit of the ions from the quadrupole rod set.

The lenses 1012 and 1014 can be implemented in a variety of different ways. For example, in some embodiments, the lenses 1012 and 1014 can be in the form of a plate having an opening through which the ions pass. In other embodiments, at least one (or both) of the lenses 1012 and 1014 can be implemented as a mesh. There can also be RF-only Brubaker lenses at the entrance and exit ends of the quadrupole.

In some embodiments, the DC voltage source can apply a resolving DC voltage to one or more of the quadrupole rods so as to select ions within a desired m/z window. In some embodiments, such a resolving DC voltage can be in a range of about 10 to about 150 V.

With continued reference to FIGS. 2A, the analyzer 1000 further includes a pulsed voltage source 1018 for applying a pulsed voltage across two opposed rods of the quadrupole rods 1004. In this embodiment, the pulsed voltage source 1018 applies a dipolar pulsed voltage to the rods 1004a and 1004b, though in other embodiments, the dipolar pulsed voltage can be applied to the rods 1004c and 1004d.

In some embodiments, the amplitude of the applied pulsed voltage can be, for example, in a range of about 10 volts to about 40 volts, or in a range of about 20 volts to about 30 volts, though other amplitudes can also be used. Further, the duration of the pulsed voltage (pulse width) can be, for example, in a range of about 10 nanoseconds (ns) to about 1 millisecond, e.g., in a range of about 1 microsecond to about 100 microseconds, or in a range of about 5 microseconds to about 50 microseconds, or in a range of about 10 microseconds to about 40 microseconds, though other pulse durations can also be used. In general, a variety of pulse amplitudes and durations can be employed. In many embodiments, the longer is the pulse width, the smaller is the pulse amplitude. Ions passing through the quadrupole are normally exposed to only a single excitation pulse. Once the “slug” of excited ions passes through the quadrupole, an additional excitation pulse is triggered. This normally occurs every 1 to 2 ms, so that about 500 to 1000 data acquisition periods are collected each second.

As discussed above, the application of the voltage pulse, e.g., across two diagonally opposed quadrupole rods, generates a transient electric field within the quadrupole, which can radially excite at least some of the ions at their secular frequencies. In many embodiments, the excitation pulse has a sufficiently short temporal duration so as to provide a broadband radial excitation of the ions within the quadrupole.

As the radially excited ions reach the end portion of the quadrupole rod set in the vicinity of the outlet (B), they will interact with the exit fringing fields. Again, without being limited to any particular theory, such an interaction can convert the radial oscillations of at least a portion of the excited ions into axial oscillations.

With particular reference to FIG. 2A, the axially oscillating ions leave the quadrupole rod set and the exit lens 1014 to reach an ion detector 1020, which operates under the control of the controller 1010. The ion detector 1020 generates a time-varying ion signal (which is herein also referred to as a transient ion signal) in response to the detection of the axially oscillating ions. A variety of detectors can be employed. Some examples of suitable detectors include, without limitation, are Photonis Channeltron Model 4822C and ETP electron multiplier Model AF610.

An analyzer 1022 (herein also referred to as an analysis module) in communication with the detector 1020 can receive the oscillating ion detection signal and apply a Fourier Transform (FT) to the received oscillating ion detection signal to derive the secular frequencies of one or more target ions of interest.

The analyzer 1022 can be configured according to the present teachings to select an optimal FT window width for application of an FT operation to the oscillating ion detection signal. As discussed above, in some embodiments, an FT window width can be selected for maximizing the intensity and/or peak width of the signal corresponding to the secular frequency of the target ion.

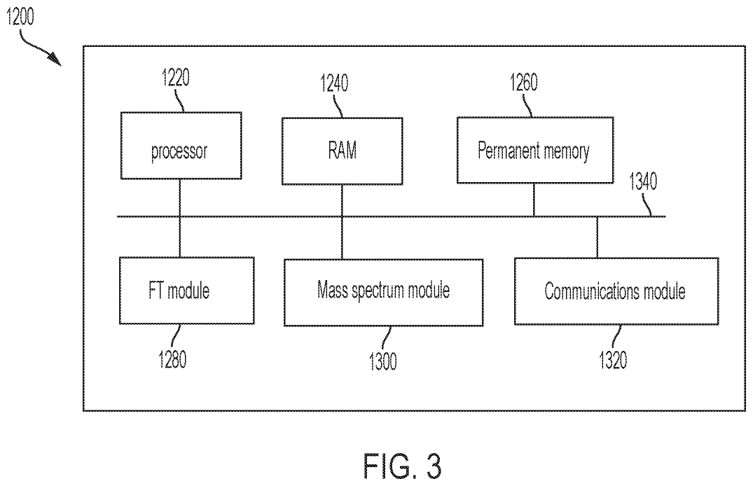

The analyzer 1022 can be implemented in hardware, firmware, and/or software in a variety of different ways. By way of example, FIG. 3 schematically depicts an embodiment of the analyzer 1200, which includes a processor 1220 for controlling the operation of the analyzer. The exemplary analyzer 1200 further includes a random-access memory (RAM) 1240 and a permanent memory 1260 for storing instructions and data.

The analyzer 1200 also includes a Fourier transform (FT) module 1280 for operating on the oscillating ion detection signal received from the detector 1180 to generate a frequency domain signal, and a module 1300 for calculating the mass spectrum of the detected ions based on the frequency domain signal, e.g., in a manner discussed herein. A communications module 1320 allows the analyzer to communicate with the ion detector 1180, e.g., to receive the detected ion signal. A communications bus 1340 allows various components of the mass analyzer to communicate with one another.

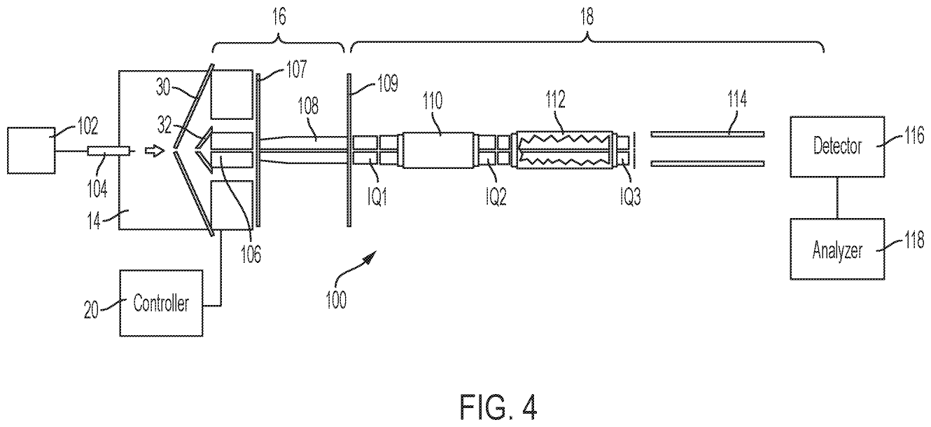

A mass analyzer according to the present teachings can be incorporated in a variety of different mass spectrometers. By way of example, FIG. 4 schematically depicts such a mass spectrometer 100, which comprises an ion source 104 for generating ions within an ionization chamber 14, an upstream section 16 for initial processing of ions received therefrom, and a downstream section 18 containing a collision cell and one or more mass analyzers, including a mass analyzer 116 configured according to the present teachings.

Ions generated by the ion source 104 can be successively transmitted through the elements of the upstream section 16 (e.g., a curtain plate 30, an orifice plate 32, Qjet 106, and Q0 108) to result in a narrow and highly focused ion beam (e.g., in the z-direction along the central longitudinal axis) for further mass analysis within the high vacuum downstream portion 18.

In the depicted embodiment, the ionization chamber 14 can be maintained at an atmospheric pressure, though in some embodiments, the ionization chamber 14 can be evacuated to a pressure lower than atmospheric pressure. The curtain chamber (i.e., the space between curtain plate 30 and orifice plate 32) can also be maintained at an elevated pressure (e.g., about atmospheric pressure, a pressure greater than the upstream section 16), while the upstream section 16, and downstream section 18 can be maintained at one or more selected pressures (e.g., the same or different sub-atmospheric pressures, a pressure lower than the ionization chamber) by evacuation through one or more vacuum pump ports (not shown). The upstream section 16 of the mass spectrometer system 100 is typically maintained at one or more elevated pressures relative to the various pressure regions of the downstream section 18, which typically operate at reduced pressures so as to promote tight focusing and control of ion movement.

The ionization chamber 14, within which analytes contained within the fluid sample discharged from the ion source 104 can be ionized, is separated from a gas curtain chamber by a curtain plate 30 defining a curtain plate aperture in fluid communication with the upstream section via the sampling orifice of an orifice plate 32. In accordance with various aspects of the present teachings, a curtain gas supply can provide a curtain gas flow (e.g., of N₂) between the curtain plate 30 and orifice plate 32 to aid in keeping the downstream section of the mass spectrometer system clean by declustering and evacuating large neutral particles.

By way of example, a portion of the curtain gas can flow out of the curtain plate aperture into the ionization chamber 14, thereby preventing the entry of droplets through the curtain plate aperture.

As discussed in detail below, the mass spectrometer system 100 also includes a power supply and a controller (not shown) that can be coupled to the various components so as to operate the mass spectrometer system 100 in accordance with various aspects of the present teachings.

As shown, the depicted system 100 includes a sample source 102 configured to provide a fluid sample to the ion source 104. The sample source 102 can be any suitable sample inlet system known to one of skill in the art and can be configured to contain and/or introduce a sample (e.g., a liquid sample containing or suspected of containing an analyte of interest) to the ion source 104. The sample source 102 can be fluidly coupled to the ion source so as to transmit a liquid sample to the ion source 102 (e.g., through one or more conduits, channels, tubing, pipes, capillary tubes, etc.) from a reservoir of the sample to be analyzed, from an in-line liquid chromatography (LC) column, from a capillary electrophoresis (CE) instrument, or an inlet through which the sample can be injected, all by way of non-limiting examples. In some aspects, the sample source 102 can comprise an infusion pump (e.g., a syringe or LC pump) for continuously flowing a liquid carrier to the ion source 104, while a plug of sample can be intermittently injected into the liquid carrier.

The ion source 104 can have a variety of configurations but is generally configured to generate ions from analytes contained within a sample (e.g., a fluid sample that is received from the sample source 102). In this embodiment, the ion source 104 comprises an electrospray electrode, which can comprise a capillary fluidly coupled to the sample source 102 and which terminates in an outlet end that at least partially extends into the ionization chamber 14 to discharge the liquid sample therein. As will be appreciated by a person skilled in the art in light of the present teachings, the outlet end of the electrospray electrode can atomize, aerosolize, nebulize, or otherwise discharge (e.g., spray with a nozzle) the liquid sample into the ionization chamber 14 to form a sample plume comprising a plurality of micro-droplets generally directed toward (e.g., in the vicinity of) the curtain plate aperture.

As is known in the art, analytes contained within the micro-droplets can be ionized (i.e., charged) by the ion source 104, for example, as the sample plume is generated. In some aspects, the outlet end of the electrospray electrode can be made of a conductive material and electrically coupled to a power supply (e.g., voltage source) operatively coupled to the controller 20 such that as fluid within the micro-droplets contained within the sample plume evaporate during desolvation in the ionization chamber 12, bare charged analyte ions or solvated ions are released and drawn toward and through the curtain plate aperture.

In some alternative aspects, the discharge end of the sprayer can be non-conductive and spray charging can occur through a conductive union or junction to apply high voltage to the liquid stream (e.g., upstream of the capillary). Though the ion source 104 is generally described herein as an electrospray electrode, it should be appreciated that any number of different ionization techniques known in the art for ionizing analytes within a sample and modified in accordance with the present teachings can be utilized as the ion source 104.

By way of non-limiting example, the ion source 104 can be an electrospray ionization device, a nebulizer assisted electrospray device, a chemical ionization device, a nebulizer assisted atomization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, DESI, among others.

It will be appreciated that the ion source 102 can be disposed orthogonally relative to the curtain plate aperture and the ion path axis such that the plume discharged from the ion source 104 is also generally directed across the face of the curtain plate aperture such that liquid droplets and/or large neutral molecules that are not drawn into the curtain chamber can be removed from the ionization chamber 14 so as to prevent accumulation and/or recirculation of the potential contaminants within the ionization chamber. In various aspects, a nebulizer gas can also be provided (e.g., about the discharge end of the ion source 102) to prevent the accumulation of droplets on the sprayer tip and/or direct the sample plume in the direction of the curtain plate aperture.

In some embodiments, upon passing through the orifice plate 32, the ions can traverse one or more additional vacuum chambers and/or quadrupoles (e.g., a QJet® quadrupole) to provide additional focusing of and finer control over the ion beam using a combination of gas dynamics and radio frequency fields prior to being transmitted into the downstream high-vacuum section 18.

In accordance with various aspects of the present teachings, it will also be appreciated that the exemplary ion guides described herein can be disposed in a variety of front-end locations of mass spectrometer systems. By way of non-limiting example, the ion guide 108 can serve in the conventional role of a QJet® ion guide (e.g., operated at a pressure of about 1-10 Torr), as a conventional Q0 focusing ion guide (e.g., operated at a pressure of about 3-15 mTorr) preceded by a QJet® ion guide, as a combined Q0 focusing ion guide and QJet® ion guide (e.g., operated at a pressure of about 3-15 mTorr), or as an intermediate device between a QJet® ion guide and Q0 (e.g., operated at a pressure in the 100s of mTorr, at a pressure between a typical QJet® ion guide and a typical Q0 focusing ion guide).

As shown, the upstream section 16 of the mass spectrometer system 100 is separated from the curtain chamber via orifice plate 32 and generally comprises a first RF ion guide 106 (e.g., QJet® of SCIEX) and a second RF guide 108 (e.g., Q0). In some exemplary aspects, the first RF ion guide 106 can be used to capture and focus ions using a combination of gas dynamics and radio frequency fields. By way of example, ions can be transmitted through the sampling orifice, where a vacuum expansion occurs as a result of the pressure differential between the chambers on either side of the orifice plate 32.

By way of non-limiting example, the pressure in the region of the first RF ion guide can be maintained at about 2.5 Torr pressure. The QJet® 106 transfers ions received thereby to subsequent ion optics such as the Q0 RF ion guide 108 through the ion lens IQ0 107 disposed therebetween. The Q0 RF ion guide 108 transports ions through an intermediate pressure region (e.g., in a range of about 1 mTorr to about 10 mTorr) and delivers ions through the IQ1 lens 109 to the downstream section 18 of system 100.

The downstream section 18 of mass spectrometer system 100 generally comprises a high vacuum chamber containing the one or more mass analyzers for further processing of the ions transmitted from the upstream section 16. As shown in FIG. 4, the exemplary downstream section 18 includes a mass analyzer 110 (e.g., elongated rod set Q1) and a second elongated rod set 112 (e.g., q2) that can be operated as a collision cell. The downstream section further includes a mass analyzer 114 according to the present teachings.

Mass analyzer 110 and collision cell 112 are separated by orifice plates IQ2, and collision cell 112 and the mass analyzer 114 are separated by orifice plate IQ3. For example, after being transmitted from 108 Q0 through the exit aperture of the lens 109 IQ1, ions can enter the adjacent quadrupole rod set 110 (Q1), which can be situated in a vacuum chamber that can be evacuated to a pressure that can be maintained at a value lower than that of chamber in which RF ion guide 107 is disposed.

By way of non-limiting example, the vacuum chamber containing Q1 can be maintained at a pressure less than about 1×10⁻⁴ Torr (e.g., about 5×10⁻⁵ Torr), though other pressures can be used for this or for other purposes. As will be appreciated by a person of skill in the art, the quadrupole rod set Q1 can be operated as a conventional transmission RF/DC quadrupole mass filter that can be employed to select an ion of interest and/or a range of ions of interest.

By way of example, the quadrupole rod set Q1 can be provided with RF/DC voltages suitable for operation in a mass-resolving mode. As should be appreciated, taking the physical and electrical properties of Q1 into account, parameters for an applied RF and DC voltage can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1.

Ions passing through the quadrupole rod set Q1 can pass through the lens IQ2 and into the adjacent quadrupole rod set q2, which can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to thermalize and/or fragment ions in the ion beam.

In this embodiment, the ions exiting the collision cell 112 can be received by the mass analyzer 114. In this embodiment, the mass analyzer 114 is implemented as a quadrupole mass analyzer, where the application of RF voltages to the quadrupole rods (with or without a selectable resolving DC voltage) can provide radial confinement of the ions as they pass through the quadrupole and the application of a DC voltage pulse across a pair of the RF rods of the electrodes can cause radial excitation of at least a portion (and preferably all) of the ions.

As discussed above, the interaction of the radially excited ions with the fringing fields as they exit the quadrupole mass analyzer can convert the radial excitation of at least some of those ions into axial excitation. The ions are then detected by a detector 118, which generates a time-varying ion signal. An analyzer 120 in communication with the detector 118 can operate on the time-varying ion signal in a manner discussed above to obtain the secular frequencies of one or more target ions of interest and use the information regarding the secular frequencies of the ions to determine a mass spectrum of the ions of interest.

The following examples are provided for further elucidation of various aspects of the present teachings, and are not intended to necessarily provide the optimal ways of practicing the present teachings or the optimal results that can be obtained.

### EXAMPLES

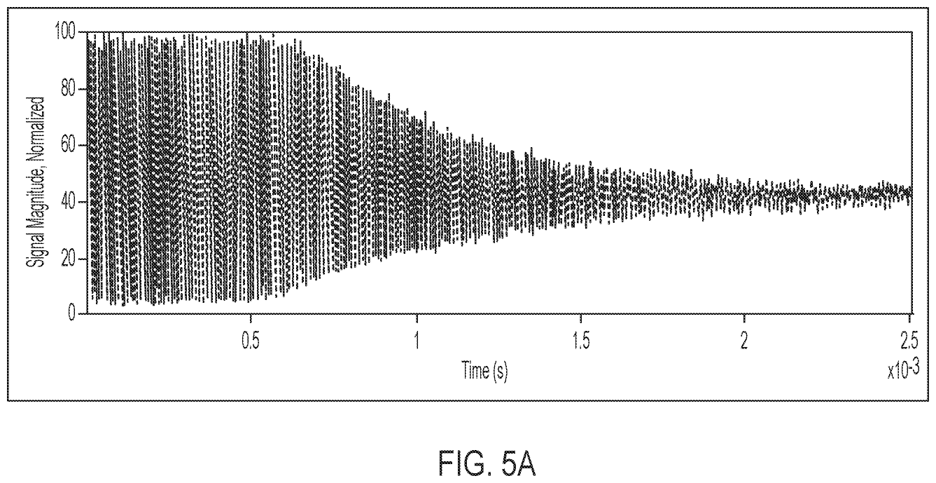

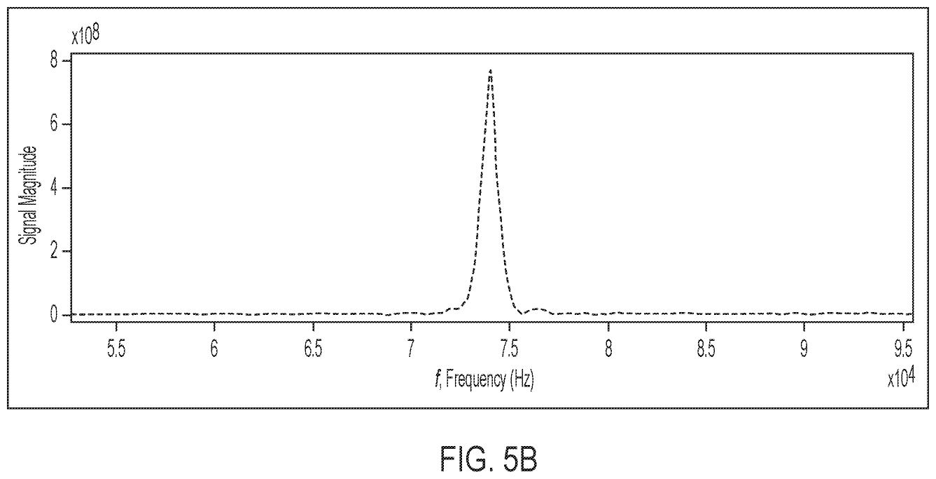

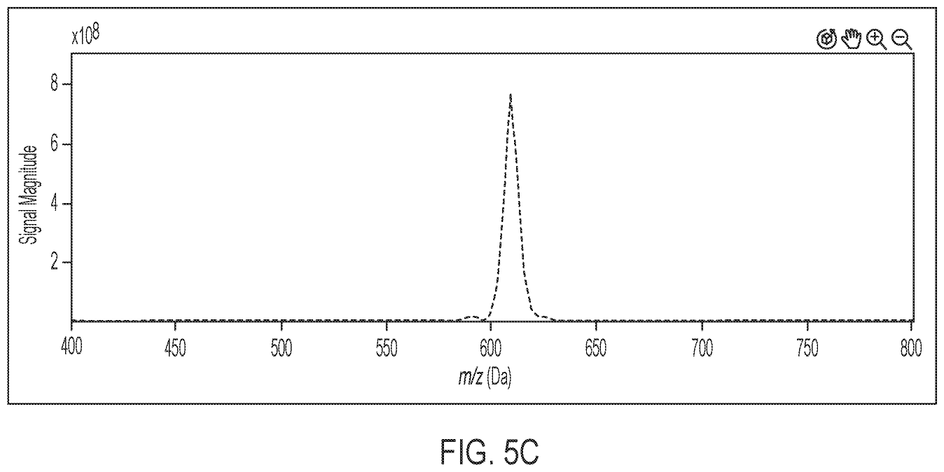

FIG. 5A shows a transient oscillating ion detection signal obtained for a protonated reserpine ion having an m/z ratio of 609 using a Fourier Transform mass spectrometer similar to the mass spectrometer discussed above in connection with FIG. 4, which is a modified Sciex QTRAP5500. The ion detection signal was acquired via application of 1 microsecond, 40-volt excitation pulse across two quadrupole rods of an FT mass analyzer of the mass spectrometer.

The presented oscillating ion detection signal is short (e.g., in this case, the duration of the oscillatory detection signal is about 1 millisecond). Although a short duration of an oscillating ion detection signal may limit the frequency resolution (i.e., the resolution of the secular frequencies associated with ions in an ion beam that have different m/z ratios), and hence the respective mass resolution, it has the advantage of allowing for fast data acquisition (e.g., on the order of

$$\frac{1}{Duration of Oscillatory Signal} ,$$

which can be, for example, in a range of about 0.5 to about 1 kHz).

FIG. 5B depicts a Fast Fourier Transform (FFT) of the oscillating ion detection signal and FIG. 5C depicts a mass spectrum obtained based on the FFT signal. The frequency of the applied RF voltage was Ω=1.33 MHz, the RF amplitude was 293 V0-p, and the ion energy was 0.25 eV.

Unlike in some other Fourier Transform Mass Spectrometer (FTMS) analyzers in which the duration of the oscillating ion detection signal depends on loss of coherence, the length of this transient signal depends almost exclusively on the residence time of the ions within the RF ion guide. This residence time is given by t=Lv, where L is the length of the quadrupole and v is the ion velocity.

In mass spectrometers in which ions having different m/z ratios, but substantially identical ion energy, enter an FT mass analyzer such as the analyzer used to obtain the above reserpine data, the differences in the m/z ratios of the ions can lead to mass-dependent ion velocities, and hence mass-dependent duration of the transient oscillating ion detection signals associated with those ions. For singly charged ions, the relative ion velocities vary as the square root their masses.

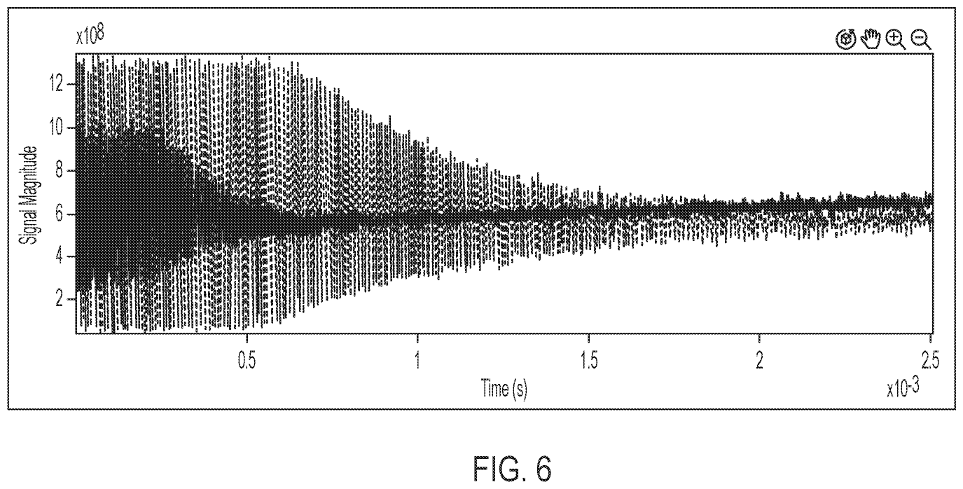

For example, as observed in FIG. 6, the duration of the oscillatory ion detection signal for singly charged reserpine ion with an m/z=609 is about 2.1 times longer than the respective duration of an oscillating ion detection signal associated with singly charged cesium ions with an

$$m / z = 132 ( \sqrt{\frac{609}{132}} \approx 2.1 ) .$$

The differences between the durations of oscillating ion detection signals for ions having the same energy but different masses increase as the differences in the molecular weights of those ions increase. For example, the duration of a transient ion detection signal for m/z=2000 is almost 4 times longer than the respective duration of a transient ion detection signal for an m/z=132.

Consequently, the use of the same FT window width for processing an oscillating ion detection signal that is composed of contributions from ions having different masses can lead to sub-optimal signal-to-noise (S/N) ratios for certain ions compared to others.

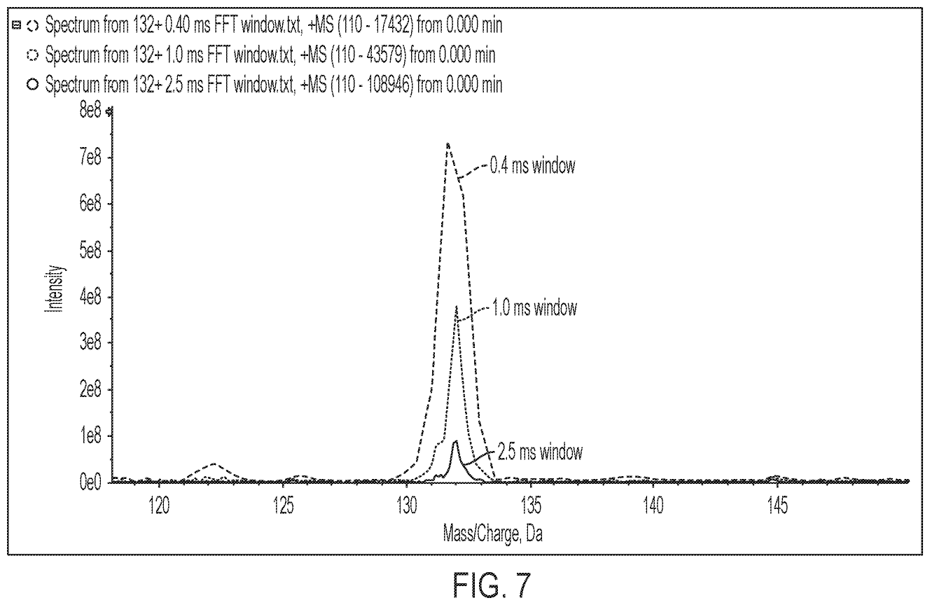

For example, FIG. 7 shows a loss of more than a factor of 8 in mass peak intensity when the FT window width for FFT analysis of an oscillating ion detection signal for singly charged cesium ion increases from 0.4 ms to 2.5 ms. The narrowing of the FFT time window can lead to some broadening of the mass peak, but in many embodiments, such broadening of the mass peaks are acceptable and can be tolerated in view of an increase in the mass peak's S/N ratio.

Those having ordinary skill in the art will appreciate that various changes can be made to the above embodiments without departing from the scope of the present teachings.

What is claimed is:

1. A mass spectrometer, comprising:
an ion source for receiving a sample and ionizing at least a portion of the sample to generate a plurality of ions,
a Fourier Transform (FT) mass analyzer configured to receive at least a portion of said plurality of ions at an inlet port thereof, said FT mass analyzer comprising a plurality of rods arranged in a multipole configuration providing a passageway for transmission of ions from said inlet port to an outlet port through which ions can exit the FT mass analyzer,
an RF voltage source for applying RF voltage(s) to said rods so as to generate an electromagnetic field within said ion passageway for radially confining the ions as they pass through the passageway,
a voltage source for applying a voltage pulse to at least one of said rods for radially exciting at least a portion of said ions at secular frequencies thereof such that an interaction of said radially excited ions with fringing fields in proximity of said outlet port converts said radial oscillations into axial oscillations as the ions exit the FT mass analyzer,
an ion detector positioned downstream of said FT mass analyzer for detecting said axially oscillating ions and generating a transient oscillating detection signal, and
an analyzer in communication with said ion detector for receiving said transient oscillating detection signal and applying a Fourier Transform to said transient oscillating detection signal to generate a spectrum of secular frequencies of said ions,
wherein said analyzer is configured to apply said FT to the transient oscillating ion signal within an FT window that is selected to optimize an intensity associated with a secular frequency of a target ion, when said target ion is present in the sample.

2. The mass spectrometer of claim 1, wherein said multipole configuration comprises a quadrupole configuration.

3. The mass spectrometer of claim 1, wherein said analyzer is configured to determine said measurement time window based on an m/z ratio associated with the target ion.

4. The mass spectrometer of claim 3, wherein said analyzer is configured to determine said measurement time window based on said determined m/z ratio of the target ion.

5. The mass spectrometer of claim 1, wherein said analyzer is configured to determine said measurement time window by initially applying an FT with a wide time window to said transient oscillating detection signal to obtain information regarding secular frequencies of said plurality of ions.

6. The mass spectrometer of claim 5, wherein said analyzer is configured to identify a secular frequency associated with a target ion from among said secular frequencies.

7. The mass spectrometer of claim 6, wherein said analyzer is configured to determine an m/z ratio of said target ion based on said identified secular frequency.

8. A method of performing mass spectrometry, comprising:
ionizing a sample to generate a plurality of ions,
introducing at least a portion of the ions into a Fourier Transform (FT) mass analyzer via an inlet thereof,
radially exciting at least a portion of the ions within the FT mass analyzer such that interaction of at least a portion of the radially excited ions with fringing fields in proximity of an outlet of said FT mass analyzer will convert radial oscillations of the excited ions into axial oscillations as the ions exit the FT mass analyzer,
detecting at least a portion of the ions exiting the FT mass analyzer so as to generate a transient oscillatory ion detection signal, and
obtaining an FT of the ion detection signal so as to generate frequency domain signals indicative of one or more secular frequencies of one or more of said ions,
wherein an FT window width associated with said ion detection signal is selected so as to optimize a secular frequency signal corresponding to at least one target ion, when said target ion is present in said plurality of ions.

9. The method of claim 8, further comprising radially confining said ions in the FT mass analyzer prior to said radial excitation.

10. The method of claim 8, wherein said FT window width is determined based on m/z ratio of said target ion.

11. The method of claim 8, wherein said FT window width is in a range of about 0.5 millisecond to about 3 milliseconds.

12. The method of claim 8, wherein said FT mass analyzer comprises a plurality of rods arranged in a multipole configuration providing a passageway for transit of the ions through the FT mass analyzer.

13. The method of claim 12, further comprising applying one or more RF voltages to said rods to provide an RF field for said radial confinement of the ions.

14. The method of claim 13, wherein said one or more RF voltages have a frequency in a range of about 0.8 MHz to about 3 MHz.

15. The method of claim 13, wherein said one or more RF voltages have a zero-to-peak amplitude in a range of about 100 volts to about 1500 volts.

16. The method of claim 12, further comprising applying a DC voltage pulse across two of said rods for causing radial excitation of the ions within said FT mass analyzer.

17. The method of claim 16, wherein said DC voltage pulse has an amplitude in a range of about 20 to about 100 volts.

18. The method of claim 16, wherein said DC voltage pulse has a duration in a range of 10 nanoseconds to about 1 millisecond.

19. The method of claim 16, wherein said DC voltage pulse has a duration in a range of about 10 nanoseconds to about 1 microsecond.

20. The method of claim 8, wherein said step of optimizing the secular frequency signal associated with the target ion comprises maximizing an intensity of said signal.
